(19) United States
(12) Patent Application Publication
(10) Pub. No.: US 2023/0224233 A1
(43) Pub. Date: Jul. 13, 2023

(54) RESOURCE ALLOCATION IN A TEST INSTRUMENT NETWORK

(71) Applicant: Keithley Instruments, LLC, Solon, OH (US)

(72) Inventor: Todd A. Hayes, Macedonia, OH (US)

(73) Assignee: Keithley Instruments, LLC, Solon, OH (US)

(21) Appl. No.: 17/990,211

(22) Filed: Nov. 18, 2022

Related U.S. Application Data
(60) Provisional application No. 63/297,639, filed on Jan. 7, 2022.

(51) Int. Cl. H04L 43/50; H04L 43/12

(52) U.S. Cl. CPC H04L 43/50; H04L 43/12

(57) ABSTRACT

A test instrument network, has a plurality of nodes, each node having a connection to the test instrument network with a unique node identifier, one or more script processors, each script processor having a unique group identifier to which resource groups can be allocated, and one or more resource groups, each resource group comprising one or more resources, wherein a node becomes a master node when it either processes a command message or initiates script processing. A method of operating a test instrument network having a plurality of nodes includes processing one or more command messages or scripts at a node having one or more script processors and one or more resource groups, designating the node processing the command message or script as a master node, sending, from a script processor on the master node, an execution request to a resource group, resource groups having a finer allocation level than a node level, and handling the request at a node that controls the resource group. A method of operating a test instrument network having a plurality of nodes has processing one or more command messages or scripts at a node, designating the node processing the command message or script as a master node, sending, from a script processor on the master node, an execution request to a resource group, verifying, at a node that controls allocation of the resource group, availability of the resource group, and allocating the resource group to the script processor when the resource group is available.

### CROSS-REFERENCE TO RELATED APPLICATIONS

This disclosure claims benefit of U.S. Provisional Application No. 63/297,639, titled “FINE-GRAINED AND DYNAMIC RESOURCE ALLOCATION IN A TEST INSTRUMENT NETWORK,” filed on Jan. 7, 2022, the disclosure of which is incorporated herein by reference in its entirety.

### TECHNICAL FIELD

This disclosure relates to test and measurement instruments, and more particularly to resource allocation techniques in a test instrument network.

### BACKGROUND

Users can network multiple test and measurement instruments into a network. Each test instrument can connect to one or more devices under test (DUT), and may include or connect to one or more processors. Typically, each processor, referred to as a script processor, can execute instructions in the form of computer code. The network can allocate resources of parallel tests to maximize efficiency.

U.S. Pat. No. 7,680,621, titled Test Instrumentation Network (hereinafter “the '621 patent”), describes one such architecture. In that example, a network consists of computing nodes, in which resource allocation of parallel tests results from assigning test nodes a group number. The master node may only issue work to a single leader within the group at a time. The group leader may freely control any resource within its group.

However, one limitation occurring in examples similar to the '621 patent results from all the instrumentation on a node is allocated as a whole. For dual-channel instruments such as the 2600B made by Keithley Instruments, both channels are allocated to the same group because they are both part of the same node. This has resulted in situations in which the network cannot fully utilize all the instrumentation resources. Instead of each channel acting as an independent resource, both channels end up grouped together as one resource because they reside on the same node.

Another limitation of the design described in the '621 patent is that the user makes the group assignments prior to starting any test that uses the groups. A more automated approach is desirable.

### BRIEF DESCRIPTION OF THE DRAWINGS

FIG. 1 shows an example of a conventional test instrument network.

FIG. 2 shows an embodiment of a test instrument network capable of having multiple script processors at one or more nodes.

FIG. 3 shows a flowchart of an embodiment of a method of operating a test instrument network.

### DETAILED DESCRIPTION

Fine-grained resource allocation, according to some embodiments of the disclosure, eliminates barriers resulting from allocation by nodes. By allowing allocation of resources at a finer level than by node, more resources become available. Such fine-grained resource allocation provides more flexibility, processing efficiency, and can lead to reduced test times.

To achieve this fine-grained allocation, the embodiments provide for nodes that can have more than one resource group per node. In the conventional approach, allocation of a node to a group resulted in allocation of all resources on the node to that group.

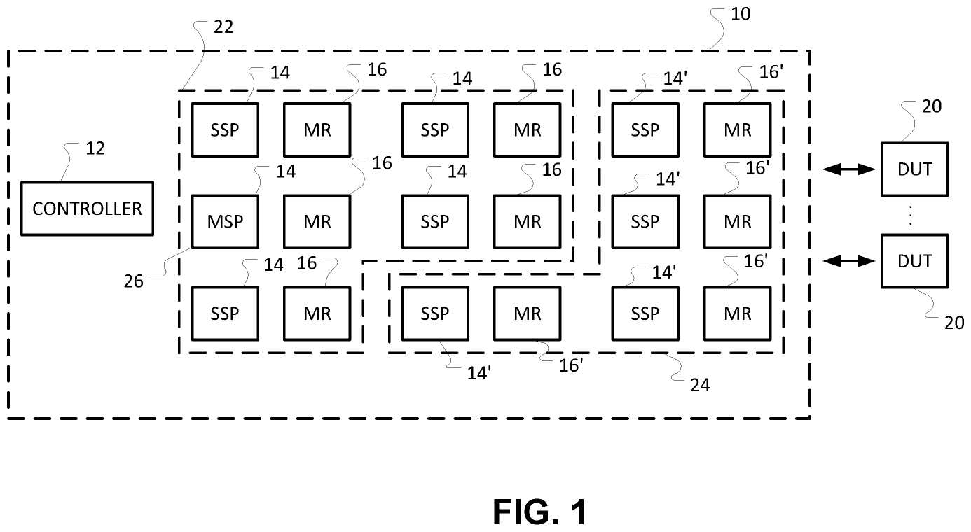

FIG. 1 shows an example of this type of allocation from U.S. Pat. No. 7,680,621, with the understanding that this provides merely an example of the type of conventional network. Referring to the figure, a test instrument network 10 includes a controller 12, script processors 14, 14′ and measurement resources 16, 16′, all of the elements of the test instrument network being capable of inter-communication. The test instrument network 10 is used to test DUTs 20.

The controller 12 may be, for example, a personal computer, a mini-computer, a workstation, or a similar computer device. The script processors 14, 14′ include a script processing engine and a scripting runtime environment. The script processors 14, 14′ may be implemented with, for example, FPGAs, microcontrollers, general-purpose processors, digital signal processors or similar control devices. The measurement resources 16, 16′ may be, for example, voltmeters, ammeters, voltage sources, current sources, source measure units, signal generators, modulators, demodulators, frequency meters, digital signal processors, timers, hardware synchronization lines, or similar devices. The controller 12, the script processors 14, 14′, and the measurement resources 16, 16′ may all communicate over any communication media including wired or wireless networks.

In one example, each script processor 14, 14′ and each collection of measurement resources 16, 16′ are paired into a test instrument. The test instrument network 10 permits the script processors 14, 14′ and the measurement resources 16, 16′ to be arbitrarily assigned into groups as desired to perform tests on the DUTs 20. For example, the group 22 may include the script processors 14 and the measurement resources 16 and the group 24 may include the script processors 14′ and the measurement resources 16′. The controller assigns the groups. It is of course possible to assign different and/or additional such groups from the elements available.

In the example shown, the group 22 includes a script processor 14 assigned to be a master script processor 26, controlled by the controller 12. The test instrument network 10 may have only one master script processor at a time, but any of the script processors 14, 14′ may be candidates. All of the other non-master script processors 14, 14′ become slave script processors. Any group that does not contain the master script processor forms a remote group, in this case, just the group 24.

The script processors 14, 14′ execute computer code, possibly in the form of test scripts, the scripts used to control the operation of measurement resources 16, 16′. The measurement resources 16, and 16′ are controlled in response to the executed computer code. The node corresponds to a script processor and one or more measurement resources in the conventional approach.

In the embodiments here, resource allocation occurs at the resource group level rather than the node level. As used here, the term “node” refers to a logical grouping of compute resources and instrumentation. These may or may not reside in one “device” such as a test instrument, or the compute resources have access to the instrumentation. The node has an independent connection to the test instrument network and has a unique identity for communication.

The term “resource group” as used here comprises a grouping of measurement resources, where a “measurement resource” or “resource” means a logical piece of controllable instrumentation. Some instrumentation may not measure anything, such as signal sources that stimulate the DUT so other resources can make a measurement. Examples include, but are not limited to, a channel on a source measurement unit (SMU), a timer, a channel on a different test instrument, or an external trigger line. A resource group comprises a unit of resource allocation that may provide an independent thread of control of the instrumentation. The system configures the resources into resource groups prior to operation, and the system dynamically allocates the resource groups to the script processors.

This allows allocation of resources at units smaller than a node. A node may have one or more resource groups, and one or more script processors. A “script processor” comprises a compute engine that runs script code and has a unique group identifier to which resource groups can be allocated.

In a conventional approach. such as that described in the '621 patent, the user assigned group numbers to the nodes. In the embodiments, the group identifiers uniquely identify script processors and are not assigned by the user. The resource groups allocated to the script processors change dynamically as script processors request resource groups for execution of commands.

The test instrument network operates in response to command messages and commands. A command message comes from the controller to the master node that results in in one or more commands to be executed by the script processor. A command comprises a portion of a command message or a script that results in the script processor issuing a request for a measurement resource to perform some operation. The term “script” as used here means a unit of code executable by a script processor. The script could take the form of a stored program on the test instrument network, in the run time environment of one of the nodes, or it could be a command message. The nonvolatile memory of an instrument could store the script to allow it to be loaded into the run time environment of the script processor. This eliminates the need for a controller.

The term “test” as used here, indicates one or more commands that cause a script processor to execute one or more operations resulting in one or more measurement resources testing the DUTs. A test may comprise as single command from within a controller command message, a script sent as a controller command message, a script started from a node, or a sequence of scripts, either in a series of controller command messages or scripts on a node.

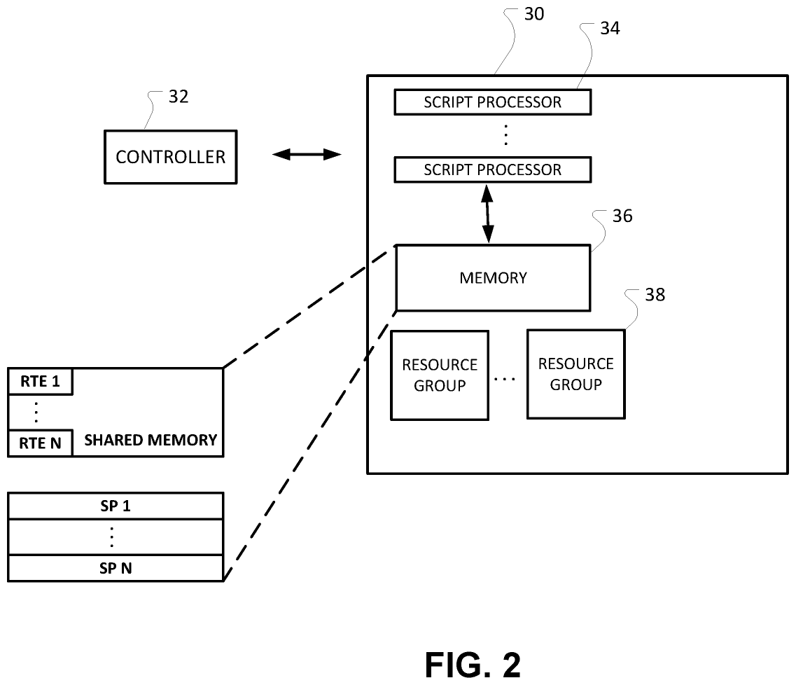

A resource group has the capability to provide a thread of execution in which commands for instrumentation within the resource group can execute. All execution requests for a channel or other fine-grained resource are directed to the thread of execution for the resource group to which the resource belongs. Having separate threads of execution for each resource group allows multiple parallel tests to issue commands to the same node without needing to queue up commands sequentially. FIG. 2 shows an embodiment of a node 30 having one or more script processors such as 34 and one or more resource groups such as 38. These nodes would be deployed in a network similar to that of FIG. 1. Each script processor has its own environment.

Each script process holds memory for its own run time environment (RTE). The memory allocated to the RTE may or may not come from a shared pool. Once allocated to a script processor, the RTE is distinct from other RTEs for other script processors. As shown in the more detailed view of the memory in FIG. 2, the memory could be a shared pool memory. Once RTEs are allocated from the memory, they are separate and distinct from other RTEs. The more detailed view also shows an instance in which each script processor could have its own memory, which it uses as needed.

In the test instrument network of FIG. 2, the controller 32 may communicate with a master node such as 30. As mentioned above, the use of a controller provides one option. In another option, the node may execute a script without a controller. Whether the commands come from a controller or from execution of script provided by a user, the node receiving the command becomes the master node. The node 30 is referred to as a master node because of its connection to the controller. Without the controller, the node 30 represents a node in the network. When the system operates without a controller, the node at which the script execution initiates becomes the master node.

The node 30 may have a physical hardware processor and either includes instrumentation, or has access to it. The node has one or more script processors such as 34, memory 36 into which a script may be loaded, and may have one or more resource groups 38. Generally, the network has nodes with one or more script processors, and the nodes control the allocation of resource groups to the script processors.

Rather than having the user assign group numbers as in conventional approaches, embodiments of the disclosure automatically track execution requests and assign resource groups to dynamically created groupings identified with the script processors. The groupings of resource groups may be handled dynamically, but the resources in the resource groups within a node are generally preconfigured.

In an example of operation, without limitation, the test instrument network may be connected to a controller in the form of a computing device such as a personal computer, etc. The computing device connects by any type of communication media available, wired, wireless, local area network (LAN), USB, PCIe, etc., to a piece of equipment, the piece of equipment comprising an instrument, residing at the node. With the increase of the capabilities of the equipment, the controller may not be necessary. The piece of equipment will typically have a processor device, such as a general-purpose processor, a digital signal processor, a field programmable gate array, etc. This becomes the master node, with the resources of the node configured into resource groups. For example, the master node may comprise an SMU having two channels. Each channel may comprise one resource group, so the node has two resource groups.

As mentioned above, the node may comprise a processing device that has access to the instrumentation equipment, in addition to the instrumentation and physical processor residing in one piece of equipment.

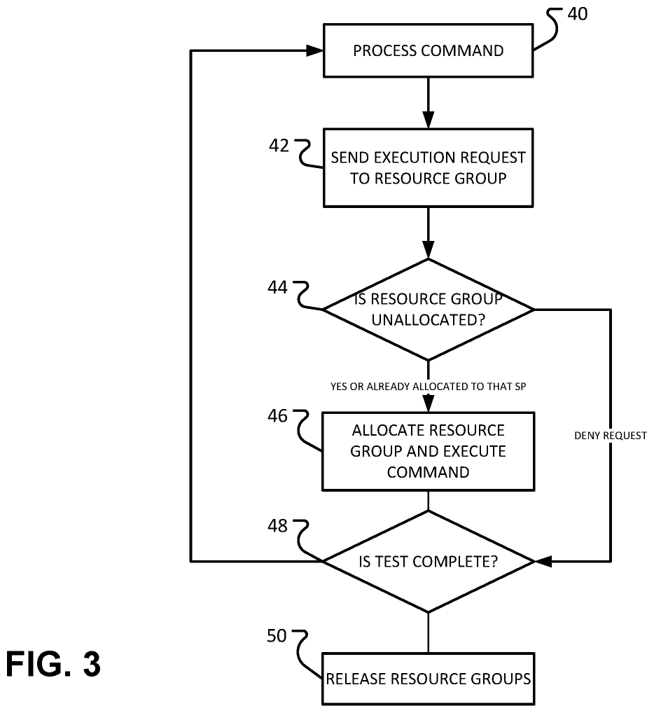

As an example of operation, shown in flowchart form in FIG. 3, without limitation, a node processes a command at 40, either as part of executing a command message received from a controller or as part of executing a stored script. The node receiving the command message or starting the script becomes the master node. A script processor on that node then begins to operate on the command.

Each command, whether direct or scripted, comprises an execution request. At each execution request 42, the script processor contacts the node that include the resource groups needed to execute the command. The resource group exists at a finer level than just at the node. The node being contacted may have several resource groups, which is a unique aspect of this system. The handling of the request such as in the embodiments of the remaining parts of the flowchart using a dynamic allocation of resources is a separate unique aspect of the system.

The node that holds the resource group potentially being allocated verifies the availability of the resource at 44. The node may allocate the resource group at that node in which the resource resides to the script processor that made the execution request at 46. This only occurs if the resource group is available. The embodiments here only allocate that resource group, such as one channel of an SMU, leaving the other channel available for other script processors.

If a resource is presently allocated to another script processor when an execution request is received by a resource, resource allocation fails at 44. The command execution is denied, with a message being sent back to the script processor that issued the request. The process then verifies whether the test is complete.

If the resource is not already allocated, it is allocated to the script processor that initiated the request at 46. A third instance may arise where the requesting script processor already has the resource group that contains the resource allocated to it. This results in the request being executed. The process then moves onto verify whether test is complete.

Upon completion of the test, whether the test comprises a command message, a single script of commands or a sequence of scripts, the resource groups allocated to the script processor will be released at 50. The release may happen in an automated fashion, with the script processor that controlled the command execution releasing the resources when the test completes. Alternatively, the user may explicitly release the resource groups allocated to that test.

In this manner, the test instrument network allows for more efficient deployment of the test resources within it. This may allow for faster parallel processing of multiple testing commands. This approach dissociates the resources and script processors from the node, allowing more than one script processor per node, and more than one resource group per node.

Aspects of the disclosure may operate on a particularly created hardware, on firmware, digital signal processors, or on a specially programmed general purpose computer including a processor operating according to programmed instructions. The terms controller or processor as used herein are intended to include microprocessors, microcomputers, Application Specific Integrated Circuits (ASICs), and dedicated hardware controllers. One or more aspects of the disclosure may be embodied in computer-usable data and computer-executable instructions, such as in one or more program modules, executed by one or more computers (including monitoring modules), or other devices. Generally, program modules include routines, programs, objects, components, data structures, etc. that perform particular tasks or implement particular abstract data types when executed by a processor in a computer or other device. The computer executable instructions may be stored on a non-transitory computer readable medium such as a hard disk, optical disk, removable storage media, solid state memory, Random Access Memory (RAM), etc. As will be appreciated by one of skill in the art, the functionality of the program modules may be combined or distributed as desired in various aspects. In addition, the functionality may be embodied in whole or in part in firmware or hardware equivalents such as integrated circuits, FPGA, and the like. Particular data structures may be used to more effectively implement one or more aspects of the disclosure, and such data structures are contemplated within the scope of computer executable instructions and computer-usable data described herein.

The disclosed aspects may be implemented, in some cases, in hardware, firmware, software, or any combination thereof. The disclosed aspects may also be implemented as instructions carried by or stored on one or more or non-transitory computer-readable media, which may be read and executed by one or more processors. Such instructions may be referred to as a computer program product. Computer-readable media, as discussed herein, means any media that can be accessed by a computing device. By way of example, and not limitation, computer-readable media may comprise computer storage media and communication media.

Computer storage media means any medium that can be used to store computer-readable information. By way of example, and not limitation, computer storage media may include RAM, ROM, Electrically Erasable Programmable Read-Only Memory (EEPROM), flash memory or other memory technology, Compact Disc Read Only Memory (CD-ROM), Digital Video Disc (DVD), or other optical disk storage, magnetic cassettes, magnetic tape, magnetic disk storage or other magnetic storage devices, and any other volatile or nonvolatile, removable or non-removable media implemented in any technology. Computer storage media excludes signals per se and transitory forms of signal transmission.

Communication media means any media that can be used for the communication of computer-readable information. By way of example, and not limitation, communication media may include coaxial cables, fiber-optic cables, air, or any other media suitable for the communication of electrical, optical, Radio Frequency (RF), infrared, acoustic or other types of signals.

Additionally, this written description makes reference to particular features. It is to be understood that the disclosure in this specification includes all possible combinations of those particular features. For example, where a particular feature is disclosed in the context of a particular aspect, that feature can also be used, to the extent possible, in the context of other aspects.

Also, when reference is made in this application to a method having two or more defined steps or operations, the defined steps or operations can be carried out in any order or simultaneously, unless the context excludes those possibilities.

### EXAMPLES

Illustrative examples of the disclosed technologies are provided below. An embodiment of the technologies may include one or more, and any combination of, the examples described below.

Example 1 is a test instrument network, comprising a plurality of nodes, each node having: a connection to the test instrument network with a unique node identifier; one or more script processors, each script processor having a unique group identifier to which resource groups can be allocated; and one or more resource groups, each resource group comprising one or more resources, wherein a node becomes a master node when it either processes a command message or initiates script processing.

Example 2 is the test instrument network of Example 1, further comprising a controller, the controller to send one or more command messages to a node that becomes the master node.

Example 3 is the test instrument network of Example 2, wherein the one or more controller command messages comprises a script.

Example 4 is the test instrument network of any of Examples 1 through 3, wherein the master node comprises a node processing a script previously stored on the node, the script comprising one or more commands.

Example 5 is the test instrument network of any of Examples 1 through 4, wherein the resource groups are fixed prior to operation of the network.

Example 6 is a method of operating a test instrument network having a plurality of nodes, comprising: processing one or more command messages or scripts at a node having one or more script processors and one or more resource groups; designating the node processing the command message or script as a master node; sending, from a script processor on the master node, an execution request to a resource group, resource groups having a finer allocation level than a node level; and handling the request at a node that controls the resource group.

Example 7 is the method of Example 6, wherein processing one or more command messages or scripts comprises receiving one or more command messages at the node.

Example 8 is the method of Example 7, wherein processing the one or more command messages or scripts starting a script stored in a memory at the node.

Example 9 is the method of and of Examples 6 through 8, further comprising allocating resource groups at the node that controls the resource group dynamically.

Example 10 is the method of Example 9, wherein the script processor has a unique identifier and resource groups allocated to script processor become part of a group having the unique identifier.

Example 11 is a method of operating a test instrument network having a plurality of nodes, comprising: processing one or more command messages or scripts at a node; designating the node processing the command message or script as a master node; sending, from a script processor on the master node, an execution request to a resource group; verifying, at a node that controls allocation of the resource group, availability of the resource group; and allocating the resource group to the script processor when the resource group is available.

Example 12 is the method of Example 11, wherein the script processor has a unique identifier and resource groups allocated to script processor become part of a group having the unique identifier.

Example 13 is the method of either of Examples 11 or 12, wherein allocating the resource group comprises notifying the script processor that the resource group was already allocated to the script processor.

Example 14 is the method of any of Examples 11 through 13, wherein allocating the resource group comprises denying allocation of the resource group to the script processor when the script processor is allocated to a different script processor.

Example 15 is the method of any of Examples 11 through 13, further comprising releasing resource groups allocated to the script processor upon completion of a test associated with the command.

Example 16 is the method of Example 15, wherein releasing resource groups comprises one of releasing the resource groups automatically or explicitly.

Example 17 is the method of any of Examples 11 through 16, wherein the sending and verifying is repeated for each execution request sent to a resource group.

Example 18 is the method of any of Examples 11 through 17, wherein the resources are preconfigured into resource groups.

Example 19 is the method of any of Examples 11 through 18, wherein processing one or more command messages or scripts comprises receiving a one or more command messages at the node.

Example 20 is the method of any of Examples 11 through 19, wherein processing the one or more command messages or scripts comprises starting a script stored in a memory at the node.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

Although specific aspects of the disclosure have been illustrated and described for purposes of illustration, it will be understood that various modifications may be made without departing from the spirit and scope of the disclosure. Accordingly, the disclosure should not be limited except as by the appended claims.

I/We claim:

1. A test instrument network, comprising a plurality of nodes, each node having:
a connection to the test instrument network with a unique node identifier;
one or more script processors, each script processor having a unique group identifier to which resource groups can be allocated; and
one or more resource groups, each resource group comprising one or more resources, wherein a node becomes a master node when it either processes a command message or initiates script processing.

2. The test instrument network as claimed in claim 1, further comprising a controller, the controller to send one or more command messages to a node that becomes the master node.

3. The test instrument network as claimed in claim 2, wherein the one or more controller command messages comprises a script.

4. The test instrument network as claimed in claim 1, wherein the master node comprises a node processing a script previously stored on the node, the script comprising one or more commands.

5. The test instrument network as claimed in claim 1, wherein the resource groups are fixed prior to operation of the network.

6. A method of operating a test instrument network having a plurality of nodes, comprising:
processing one or more command messages or scripts at a node having one or more script processors and one or more resource groups;
designating the node processing the command message or script as a master node;
sending, from a script processor on the master node, an execution request to a resource group, resource groups having a finer allocation level than a node level; and
handling the request at a node that controls the resource group.

7. The method as claimed in claim 6, wherein processing one or more command messages or scripts comprises receiving one or more command messages at the node.

8. The method as claimed in claim 7, wherein processing the one or more command messages or scripts starting a script stored in a memory at the node.

9. The method as claimed in claim 6, further comprising allocating resource groups at the node that controls the resource group dynamically.

10. The method as claimed in claim 9, wherein the script processor has a unique identifier and resource groups allocated to script processor become part of a group having the unique identifier.

11. A method of operating a test instrument network having a plurality of nodes, comprising:
processing one or more command messages or scripts at a node;
designating the node processing the command message or script as a master node;
sending, from a script processor on the master node, an execution request to a resource group;
verifying, at a node that controls allocation of the resource group, availability of the resource group; and
allocating the resource group to the script processor when the resource group is available.

12. The method as claimed in claim 11, wherein the script processor has a unique identifier and resource groups allocated to script processor become part of a group having the unique identifier.

13. The method as claimed in claim 11, wherein allocating the resource group comprises notifying the script processor that the resource group was already allocated to the script processor.

14. The method as claimed in claim 11, wherein allocating the resource group comprises denying allocation of the resource group to the script processor when the script processor is allocated to a different script processor.

15. The method as claimed in claim 11, further comprising releasing resource groups allocated to the script processor upon completion of a test associated with the command.

16. The method as claimed in claim 15, wherein releasing resource groups comprises one of releasing the resource groups automatically or explicitly.

17. The method as claimed in claim 11, wherein the sending and verifying is repeated for each execution request sent to a resource group.

18. The method as claimed in claim 11, wherein the resources are preconfigured into resource groups.

19. The method as claimed in claim 11, wherein processing one or more command messages or scripts comprises receiving a one or more command messages at the node.

20. The method as claimed in claim 11, wherein processing the one or more command messages or scripts comprises starting a script stored in a memory at the node.
